(19) United States
(12) Patent Application Publication
(10) Pub. No.: US 2008/0224612 A1
(43) Pub. Date: Sep. 18, 2008

(54) Plasma display panel (PDP) and its method of manufacture

(76) Inventor: Jung-Suk Song, Suwon-si (KR)

Correspondence Address: ROBERT E. BUSHNELL, 1522 K STREET NW, SUITE 300, WASHINGTON, DC, 20005-1202, US

(21) Appl. No.: 12/074,068

(22) Filed: Feb. 29, 2008

(30) Foreign Application Priority Data
Mar. 16, 2007 (KR) 10-2007-0026188

(51) Int. Cl. H01J 17/49; H01J 9/02

(52) U.S. Cl. 313/586; 445/24

(57) ABSTRACT

A plasma display panel (PDP) having excellent exhaust efficiency and reduced reflection of external light and its method of manufacture includes: a substrate, colored barrier ribs to partition a discharge space into a non-discharge area and a discharge area, a colored first dielectric layer arranged in the non-discharge area, and a second dielectric layer disposed in the discharge area and having a higher brightness than that of the first dielectric layer.

### CLAIM OF PRIORITY

This application makes reference to, incorporates the same herein, and claims all benefits accruing under 35 U.S.C. §119 from an application for PLASMA DISPLAY PANEL AND METHOD OF PREPARING THE SAME earlier filed in the Korean Intellectual Property Office on 16 Mar. 2007 and there duly assigned Serial No. 10-2007-0026188.

### BACKGROUND OF THE INVENTION

1. Field of the Invention

The present invention relates to a Plasma Display Panel (PDP) having excellent exhaust efficiency and reduced reflection of external light and its method of manufacture.

2. Description of the Related Art

Generally, a plasma display panel (PDP) includes an upper panel and a lower panel with a plurality of barrier ribs formed therebetween to define a plurality of discharge cells. Phosphor layers are coated on the inner walls of the discharge cells. A primary discharge gas, such as Ne, He, or a mixed gas including Ne, He and so on, and an inert gas that may include a small amount of Xe, is injected into the cells.

When a high frequency voltage is supplied to the PDP, the inert gas generates vacuum ultraviolet (VUV) rays that excite the phosphor layers coated on the inner walls of the discharge cells to generate visible light, thereby displaying images.

With the conventional PDP, a plurality of barrier ribs are formed in a matrix pattern to form a plurality of discharge areas. However, since there is no exhaust passage, the exhaust efficiency of the PDP may deteriorate.

To address the above problem, a double barrier structure has been proposed to define an exhaust passage within a barrier rib member. In the double barrier structure, barrier ribs are partially etched to expose a lower electric layer, thereby forming the exhaust passage within the barrier rib member. The lower electric layer is formed as a white layer in order to improve light reflection of the phosphors, and the barrier ribs are colored in order to increase a bright room contrast ratio. The lower electric layer formed as the white layer is exposed by the exhaust passage formed between the colored barrier ribs. Accordingly, a colored barrier rib portion and an exhaust passage portion have different reflection levels, thereby lowering bright room contrast.

### SUMMARY OF THE INVENTION

The present invention provides a Plasma Display Panel (PDP) having improved reliability with high exhaust efficiency and reduced reflection of external light.

The present invention also provides a method of manufacturing a Plasma Display Panel (PDP) having improved reliability with high exhaust efficiency and reduced reflection of external light.

According to one aspect of the present invention, a Plasma Display Panel (PDP) is provided including: a substrate; colored barrier ribs partitioning a discharge space on the substrate into a non-discharge area and a discharge area; a colored first dielectric layer arranged in the non-discharge area; and a second dielectric layer arranged in the discharge area and having a higher brightness than that of the first dielectric layer.

The PDP may further include an exhaust passage arranged in the non-discharge area.

The first dielectric layer may be arranged on an entire surface of the substrate.

The second dielectric layer may be arranged on the first dielectric layer only in the discharge area.

The barrier ribs may have a double barrier rib structure. The barrier ribs may include first barrier ribs having a double barrier rib structure and second barrier ribs crossing the first barrier ribs.

A non-display area may be arranged within the first barrier ribs.

One display area may be arranged between an adjacent pair of the first barrier ribs and an adjacent pair of the second barrier ribs.

The barrier ribs and the first dielectric layer may include a colored pigment. The barrier ribs and the first dielectric layer may include a metal selected from a group consisting of Cr, Co, Mn, Ru, Cu, Sb, and a combination thereof.

The second dielectric layer may include TiO₂.

The PDP may further include discharge electrodes arranged on the substrate and covered by the first dielectric layer.

According to another aspect of the present invention, a method of manufacturing a Plasma Display Panel (PDP) is provided, the method including: forming a colored first dielectric layer on a substrate; forming colored barrier ribs on the substrate to define a non-discharge area and a discharge area; and forming a second dielectric layer only in portions of the substrate arranged in the discharge area, the second dielectric layer having a higher brightness than that of the first dielectric layer.

The method may further include forming another first dielectric layer on the substrate only in the non-display area.

The barrier ribs may be formed after the second dielectric layer has been formed in the discharge area. The barrier ribs may also be formed after the first dielectric layer has been formed and before the second dielectric layer has been formed. The barrier ribs may be formed to have a double barrier rib structure.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a Plasma Display Panel (PDP) according to an embodiment of the present invention;

FIG. 2 is a cross-sectional view of the PDP taken along line II-II of FIG. 1;

FIG. 3 is a cross-sectional view of the PDP taken along line III-III of FIG. 1; and

FIG. 4 is a plan view of a lower panel of the PDP of FIG. 1.

### DETAILED DESCRIPTION OF THE INVENTION

The present invention is described more fully below with reference to the accompanying drawings, in which exemplary embodiments of the present invention are shown.

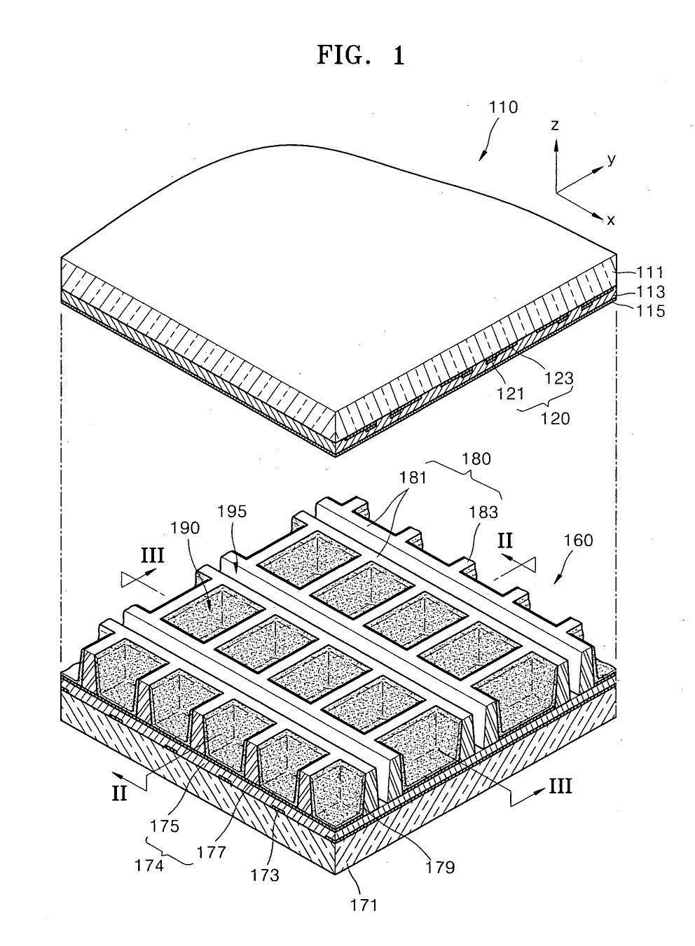

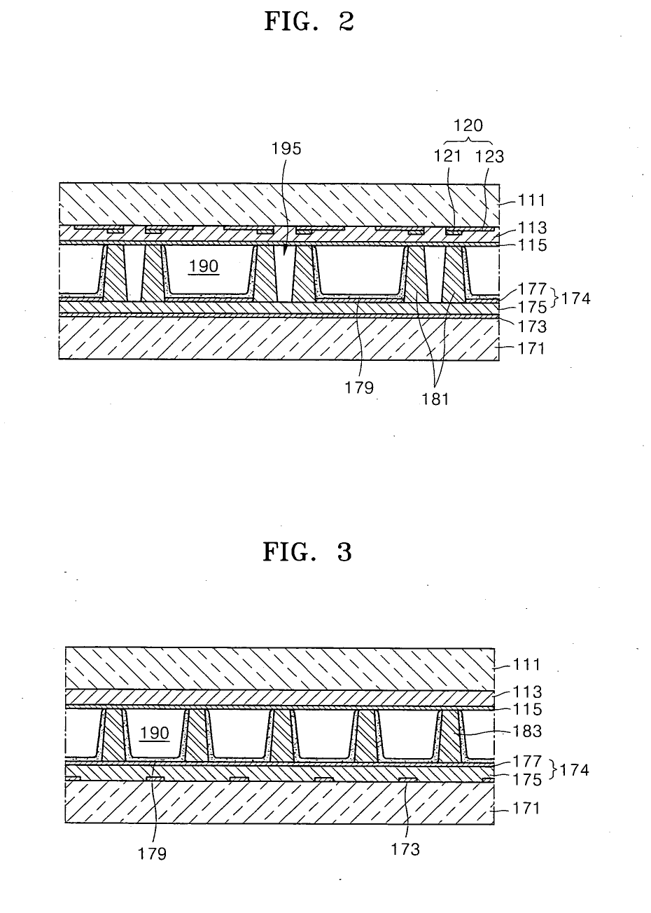

FIG. 1 is an exploded perspective view of a plasma display panel (PDP) according to an embodiment of the present invention, FIG. 2 is a cross-sectional view of the PDP taken along the line II-II of FIG. 1, and FIG. 3 is a cross-sectional view of the PDP taken along the line III-III of FIG. 1.

The PDP includes an upper panel 110 and a lower panel 160.

The upper panel 150 includes a front substrate 111, sustain electrodes 120, an upper dielectric layer 113, and a protective layer 115.

The lower panel 160 includes a second substrate 171, address electrodes 173, a lower dielectric layer 174, a phosphor layer 179, and barrier ribs 180.

The front substrate 111 and the second substrate 171 are generally transparent substrates made of, for example, soda lime glass, translucent substrates, or colored substrates.

A discharge space between the front substrate 111 and the second substrate 171 is partitioned by the barrier ribs 180. The barrier ribs 180 include first barrier ribs 181 extending in an X-axis direction and second barrier ribs 183 extending in a Y-axis direction crossing the X-axis direction. The first barrier ribs 181 are formed in a double barrier structure and as such a non-discharge area 195 is formed. In addition, a display area 190 is defined by an adjacent pair of the first barrier ribs 181 and an adjacent pair of the second barrier ribs 183.

The non-discharge area 195 is an exhaust passage. Although striped barrier ribs are shown in the present exemplary embodiment, the present invention is not limited thereto and the barrier ribs may be formed in various shapes. For example, the barrier ribs 180 may be formed in a matrix shape in which a support body is formed in the non-discharge area 195.

Furthermore, while in the present exemplary embodiment the display area 190 is formed in a matrix shape in which the first barrier ribs 181 and the second the second barrier ribs 183 are arranged so that the cross section of the display area 190 is rectangular, the present invention is not limited thereto and the display area 190 may be formed in various shapes. For example, the cross section of the display area 190 may be a circle, an ellipse, a polygon or the like.

A plurality of sustaining electrodes 120 are arranged parallel to each other in an X-axis direction on the first substrate 111. The sustaining electrodes 120 include bus electrodes 121 and transparent electrodes 123.

The bus electrodes 121 compensate for a relatively high resistance level of the transparent electrodes 123 to allow substantially the same voltage to be supplied to a plurality of discharge cells, and are made of, for example, chrome (Cr), copper (Cu), or aluminum (Al). The transparent electrodes 123 induce and sustain discharges in the respective discharge cells, and are made of a material having a relatively high visible light transmission and a low resistance, for example, Indium Tin Oxide (ITO).

The upper dielectric layer 113 is provided on the first substrate 111 to cover the sustaining electrodes 120. The upper dielectric layer 113 limits a discharge current to sustain a glow discharge, reduces a memory function and a voltage supplied through the accumulation of wall charges, and is made of a highly dielectric material, such as PbO—B₂O₃—SiO₂O₃.

The protective layer 115 is formed on the upper dielectric layer 113. The protective layer 115 protects the upper dielectric layer 113 from charged particles colliding thereon. Furthermore, the protective layer 115 emits secondary electrons to thus reduce a discharge voltage, and may be made of, for example, magnesium oxide (MgO).

A plurality of address electrodes 173 extending parallel to each other in a Y-axis direction crossing the X-axis direction are formed on the second substrate 171. A lower dielectric layer is formed on the second substrate 171 having the plurality of address electrodes 173 arranged thereon.

In more detail, the lower dielectric layer 174 consists of a first lower dielectric layer 175, which is a colored layer and is disposed on the entire surface of the second substrate 171, and a second lower dielectric layer 177, which is a white layer and is disposed only on the discharge area 190 of the first lower dielectric layer 175.

The first lower dielectric layer 175 may be black, as well as brown, dark blue and so on. The second lower dielectric layer 177 may be formed with a color having a higher brightness than the first lower dielectric layer 175. Therefore, the second lower dielectric layer 177 may be formed as a white layer using TiO₂ to enhance the light reflectance of phosphors in the discharge area. The term “white” includes not only pure white but also includes colors having a good of light reflecting property.

A withstand voltage of the lower dielectric layer may be increased by primarily forming the first lower dielectric layer 175 as a colored layer on the entire surface of the second substrate 171. Table 1 demonstrates results of measuring withstand voltages of a dielectric layer having no TiO₂, i.e., a colored dielectric layer, and dielectric layers having 3.1% TiO₂ and 10% TiO₂, i.e., white dielectric layers. As evident from Table 1, the withstand voltage of the dielectric layer having no TiO₂, which is a colored dielectric layer, is about 10% higher than that of the dielectric layers having 3.1% TiO₂ and 10% TiO₂. Accordingly, as illustrated in the present exemplary embodiment, the overall withstand voltage of the lower dielectric layer can be increased by primarily forming the first lower dielectric layer 175 as a colored layer having no TiO₂ on the entire surface of the second substrate 171 and secondly forming the second lower dielectric layer 177 as a white layer having TiO₂ only on the discharge area 190.

TABLE 1

| | TiO₂ 0% | TiO₂ 3.1% | TiO₂ 10% |
|---|---|---|---|
| Withstand | 553 | 497 | 449 |
| voltage (V) | | | |

The first lower dielectric layer 175 and the second lower dielectric layer 177 are disposed on the discharge area 190 and only the first lower dielectric layer 175 is disposed on the non-discharge area 195, so that a bottom of the discharge area 190 is white and the non-discharge area 195 can be colored with the same pigment as the barrier ribs 180. Thus, the light reflectance of phosphors can be enhanced in the discharge area 190 and reflection of external light can be reduced in the non-display area 195 and the barrier ribs 180 by the non-display area 195 and the barrier ribs 180 being colored.

However, the present invention is not limited to the illustrated exemplary embodiment. For example, in order to increase a withstand voltage characteristic of a dielectric layer, the present invention can also be applied to a modified version of the PDP in which a colored first lower dielectric layer is formed on the entire surface of a second substrate, a white second lower dielectric layer formed on the first lower dielectric layer of the display area, and another colored first lower dielectric layer formed on the first dielectric layer portions of the non-display area.

The first lower dielectric layer 175 contains a colored pigment, or may be colored, inclusive of a metal, such as Cr, Co, Mn, Ru, Cu, Sb, or the like.

In the above-described PDP, the second lower dielectric layer 177 can be formed as a white layer so that the light reflectance of the phosphors can be enhanced in the discharge area 190.

In the display area 190, the phosphor layer 179 is arranged on the second lower dielectric layer 177 and the barrier ribs 180. The phosphor layer 179 is excited by UV rays generated by a discharge gas to emit visible light. For a full color display, the phosphor layer 179 has a red-emitting phosphor layer, a green-emitting phosphor layer, or a blue-emitting phosphor layer arranged in each display area. According to the type of the phosphor layer 179, the phosphor layer 179 is separated into red discharge cells, green discharge cells, and blue discharge cells. In more detail, a red-emitting phosphor may be made of Y(V,P)O₄:Eu, etc., a green-emitting phosphor may be made of Zn₂SiO₄:Mn, YBO₃:Tb, etc., and a blue-emitting phosphor may be made of BAM:Eu, etc.

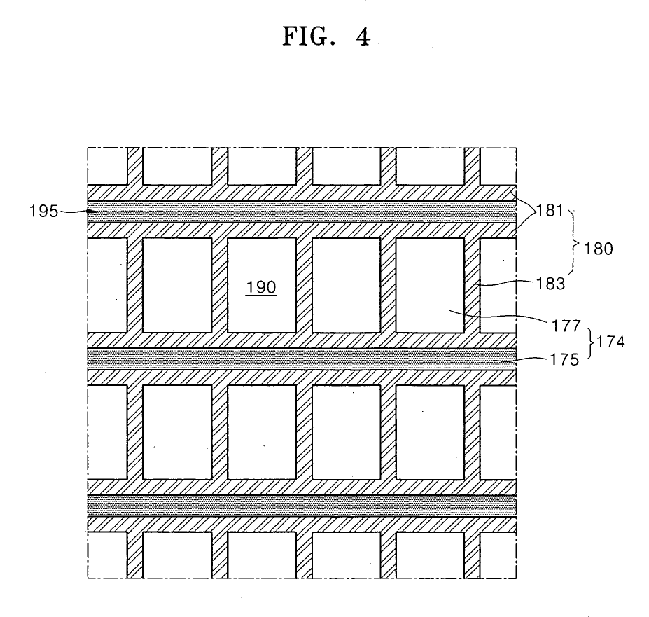

FIG. 4 is a plan view of a lower panel of the PDP of FIG. 1.

Referring to FIG. 4, the barrier ribs 180 and the non-display area 195 are colored and the display area 190 is white. The colored first lower dielectric layer 175 is exposed in the non-display area 195, and the second lower dielectric layer 177 of white-series color is exposed in the display area 190. Accordingly, the light reflectance of phosphors can be enhanced in the discharge area 190 and reflection of external light can be reduced in the non-display area 195 and the barrier ribs 180 by the non-display area 195 and the barrier ribs 180 being colored.

Preferably, the first lower dielectric layer 175 is primarily formed on the entire surface of the second substrate 171, and the second lower dielectric layer 177 is selectively formed only on the discharge area 190. Since the withstand voltage of the colored first dielectric layer 175 having no TiO₂ is higher than that of the second dielectric layer 177 of white-series color having TiO₂, the first dielectric layer 175 can be formed on the entire surface of the second substrate 171.

Hereinafter, a method of manufacturing the PDP according to an embodiment of the present invention is described in detail.

In a method of manufacturing the PDP according to an exemplary embodiment of the present invention, a first paste for forming the first dielectric layer 175 is coated on the second substrate 171 having the address electrodes 173, and the coated first paste is dried and fired. The drying and firing steps of the first paste may be skipped. In such a case, the barrier ribs 180 are preferably formed by chemical etching. The first paste may contain a colored pigment or a metal, such as Cr, Co, Mn, Ru, Cu, or Sb.

A second paste for forming the barrier ribs 180 is coated on the first lower dielectric layer 175 and etched in a predetermined pattern to expose the first lower dielectric layer 175, thereby forming the first and second barrier ribs 181 and 183. The first barrier ribs 181 are formed in a double barrier structure, so that the non-discharge area 195, that is, an exhaust passage, is formed in the first barrier ribs 181. The display area 190 is defined between an adjacent pair of the first barrier ribs 181 and an adjacent pair of the second barrier ribs 183. The second paste is etched through chemical etching using an etchant or physical etching using sand blasting.

Next, a third paste for forming the white second lower dielectric layer 177 is selectively coated only on the display area 190, and the coated third paste is dried and fired. Another colored first lower dielectric layer 175 may further be formed on the non-display area 195.

In a method of manufacturing the PDP according to another exemplary embodiment of the present invention, the first paste is primarily coated on the entire surface of the second substrate, and the coated first paste is dried and fired, thereby forming the first lower dielectric layer. The third paste for forming the second lower dielectric layer is selectively coated on the first lower dielectric layer where the display area is to be formed, and the selectively coated third paste is dried and fired. The second paste for forming the barrier ribs is coated on the resultant structure and then etched so as to form the barrier ribs and appropriately expose the second lower dielectric layer and the first lower dielectric layer.

In an alternative embodiment of the present invention, the first lower dielectric layer is primarily formed on the entire surface of the second substrate, the second lower dielectric layer is formed on the first lower dielectric layer where the display area is to be formed, and the colored first lower dielectric layer is formed on portions of the first lower dielectric layer where the non-display area is to be formed. After forming the second lower dielectric layer and another first lower dielectric layer, the colored barrier ribs are formed on the resultant structure.

As described above, according to the present invention, a PDP having improved reliability, an improved withstand voltage, a reduced reflection of external light and an enhanced luminous efficiency can be manufactured by forming barrier ribs in a double barrier structure so as to form an exhaust passage providing high exhaust efficiency and by forming a colored first dielectric layer on a substrate while selectively forming a white second dielectric layer only on a display area of the first dielectric layer.

In addition, the present invention provides for a method of manufacturing the PDP in a simplified manner having improved reliability.

While the present invention has been particularly shown and described with reference to exemplary embodiments thereof, it will be understood by those of ordinary skill in the art that various modifications in form and detail may be made therein without departing from the spirit and scope of the present invention as defined by the following claims.

What is claimed is:

1. A Plasma Display Panel (PDP) comprising:
a substrate;
colored barrier ribs partitioning a discharge space on the substrate into a non-discharge area and a discharge area;
a colored first dielectric layer arranged in the non-discharge area; and
a second dielectric layer arranged in the discharge area and having a higher brightness than that of the first dielectric layer.

2. The PDP of claim 1, further comprising an exhaust passage arranged in the non-discharge area.

3. The PDP of claim 1, wherein the first dielectric layer is arranged on an entire surface of the substrate.

4. The PDP of claim 3, wherein the second dielectric layer is arranged on the first dielectric layer only in the discharge area.

5. The PDP of claim 1, wherein the barrier ribs comprise a double barrier rib structure.

6. The PDP of claim 1, wherein the barrier ribs comprise first barrier ribs having a double barrier rib structure and second barrier ribs crossing the first barrier ribs.

7. The PDP of claim 6, wherein a non-display area is arranged within the first barrier ribs.

8. The PDP of claim 6, wherein one display area is arranged between an adjacent pair of the first barrier ribs and an adjacent pair of the second barrier ribs.

9. The PDP of claim 1, wherein the barrier ribs and the first dielectric layer comprise a colored pigment.

10. The PDP of claim 1, wherein the barrier ribs and the first dielectric layer comprise a metal selected from a group consisting of Cr, Co, Mn, Ru, Cu, Sb, and a combination thereof.

11. The PDP of claim 1, wherein the second dielectric layer comprises TiO₂.

12. The PDP of claim 1, further comprising discharge electrodes arranged on the substrate and covered by the first dielectric layer.

13. A method of manufacturing a Plasma Display Panel (PDP), the method comprising:
forming a colored first dielectric layer on a substrate;
forming colored barrier ribs on the substrate to define a non-discharge area and a discharge area; and
forming a second dielectric layer only in portions of the substrate arranged in the discharge area, the second dielectric layer having a higher brightness than that of the first dielectric layer.

14. The method of claim 13, further comprising forming another first dielectric layer on the substrate only in the non-display area.

15. The method of claim 13, wherein the barrier ribs are formed after the second dielectric layer has been formed in the discharge area.

16. The method of claim 13, wherein the barrier ribs are formed after the first dielectric layer has been formed and before the second dielectric layer has been formed.

17. The method of claim 16, wherein the barrier ribs are formed to have a double barrier rib structure.
